(19) United States
(12) Patent Application Publication
(10) Pub. No.: US 2010/0103472 A1
(43) Pub. Date: Apr. 29, 2010

(54) METHOD OF SENDING E-MAIL BY USING E-MAIL ADDRESS BOOK, AND IMAGE FORMING APPARATUS USING THE METHOD

(75) Inventor: Han-nam KIM, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 12/537,291

(22) Filed: Aug. 7, 2009

(30) Foreign Application Priority Data
Oct. 28, 2008 (KR) 2008-105923

(51) Int. Cl. H04N 1/00; G06F 15/16

(52) U.S. Cl. 358/402; 709/206

(57) ABSTRACT

A method of creating an e-mail address book and sending an e-mail by using the e-mail address book in an image forming apparatus, and an image forming apparatus using the method. A method of sending an e-mail by using an e-mail address book in an image forming apparatus capable of scanning a document, includes receiving basic information of at least one receiver and a scan option corresponding to the at least one receiver; storing the basic information and the scan option in the e-mail address book; selecting a receiver from the e-mail address book; scanning the document in accordance with a scanning option corresponding to the selected receiver; attaching the scanned document to the e-mail and sending the e-mail to the selected receiver

### CROSS-REFERENCE TO RELATED APPLICATIONS

This application claims priority under 35 U.S.C. §119 from Korean Patent Application No. 10-2008-0105923, filed on Oct. 28, 2008, in the Korean Intellectual Property Office, the disclosure of which is incorporated herein in its entirety by reference.

### BACKGROUND

1. Field of the Invention

The present general inventive concept relates to an image forming apparatus to send an e-mail, and more particularly, to a method of sending an e-mail in an image forming apparatus by using an e-mail address book in which scan options are set based on receivers, and an image forming apparatus using the method.

2. Description of the Related Art

As various image formats, such as gif, jpeg, bmp, tiff, and pdf, can be applied to e-mails, a complex procedure, such as image conversion, can be required to a receiver in order to view an image file attached to an e-mail after receiving the e-mail. Such a procedure is demanded to, for example, a Web 2.0 server or a private server and thus can be seriously considered.

If a receiver of an image file can determine a desired format and change the image file to the desired format, image processing can be performed much more efficiently.

### SUMMARY

The present general inventive concept provides a method of sending an e-mail in an image forming apparatus by using an e-mail address book in which scan options are set based on receivers.

The present general inventive concept also provides an image forming apparatus to send an image file that is scanned in accordance with scan options set based on receivers, through an e-mail.

Additional aspects and utilities of the present general inventive concept will be set forth in part in the description which follows and, in part, will be obvious from the description, or may be learned by practice of the general inventive concept.

The foregoing and other aspects and utilities of the present general inventive concept may be achieved by providing a method of sending an e-mail by using an e-mail address book in an image forming apparatus capable of scanning a document, the method including receiving basic information of at least one receiver and a scan option corresponding to the at least one receiver, storing the basic information and the scan option in the e-mail address book, selecting a receiver from the e-mail address book; scanning the document in accordance with a scanning option corresponding to the selected receiver, and attaching the scanned document to the e-mail and sending the e-mail to the selected receiver.

The foregoing and other aspects and utilities of the present general inventive concept may also be achieved by providing an image forming apparatus including a scan unit for scanning a document in accordance with a scan option corresponding to at least one receiver; an e-mail sending unit to attach the scanned document to an e-mail and to send the e-mail to the at least one receiver, a user interface to receive basic information of the at least one receiver and a scan option corresponding to the at least one receiver, a storage to store an e-mail address book including the basic information and the scan option, and a control unit to control the scan unit to scan the document in accordance with the basic information and the scan option, and to control the e-mail sending unit to attach the scanned document to the e-mail and to send the e-mail to the at least one receiver.

The foregoing and other aspects and utilities of the present general inventive concept may also be achieved by providing an apparatus to send an email according to an email option of a document scanned in an image forming apparatus, including a user interface to set the email option applied to a designated receiver, and a controller to send the email with an attachment formed according to the set email option to the designated receiver.

The user interface may set another email option applied to another designated email, and the controller may send anther email with another attachment according to the set another email option of the another designated receiver.

The first email option may not be applied to the second email and the second email option may not be applied to the first email.

The first email option may be a first format of the attachment, and the second email option may be a second format of the another attachment.

The apparatus may further include a scanning unit to scan a document, and the controller may create the attachment from the scanned document according to the email option and also create the another attachment from the scanned document according to the another email option.

The email option may include a plurality of email options, the receiver may include a plurality of receivers, the user interface may create an email address book having a first group of receivers having the same one of the email options and a second group of receivers having the same another one of the email options.

The attachment may include a plurality of attachments, and the controller may create the plurality of attachments formed from a common file according to the corresponding email options and then may send the emails with different attachment formed according to the corresponding email options to the respective first and second group of receivers.

### BRIEF DESCRIPTION OF THE DRAWINGS

The above and other features and advantages of the present general inventive concept will become more apparent by describing in detail exemplary embodiments thereof with reference to the attached drawings in which:

FIG. 1 is an image of a setup screen to register an e-mail address on an e-mail address book;

FIG. 2 is an image of a setup screen illustrating an e-mail address book;

FIG. 3 is an image of a setup screen illustrating a method of setting a scan option of an image file to be sent through an e-mail;

FIG. 4 is a flowchart illustrating a method of creating an e-mail address book in an image forming apparatus, according to an embodiment of the present general inventive concept;

FIG. 5 is an image of a setup screen to register an e-mail address and a scan option on an e-mail address book, according to an embodiment of the present general inventive concept;

FIG. 6 is a flowchart illustrating a method of sending an e-mail in an image forming apparatus, according to an embodiment of the present general inventive concept;

FIG. 7 is a block diagram illustrating an image forming apparatus to send an e-mail in accordance with scan options set based on receivers, according to an embodiment of the present general inventive concept;

FIG. 8 is a block diagram illustrating an email system according to an embodiment of the present general inventive concept;

FIG. 9 is a flow chart illustrating a method of creating an email address book according to an embodiment of the present general inventive concept;

FIG. 10 is a flow chart illustrating a method of creating an email address book according to an embodiment of the present general inventive concept; and

FIG. 11 is a flow chart illustrating a method of creating a first group and a second group with a first file format and a second file format, respectively, according to an embodiment of the present general inventive concept.

### DETAILED DESCRIPTION OF THE EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

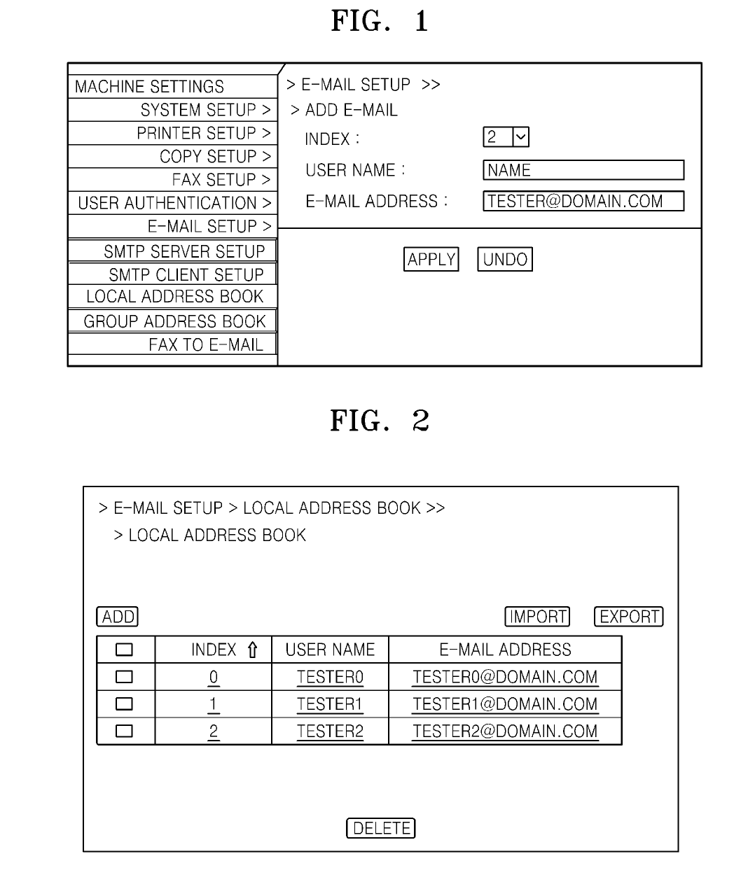

FIG. 1 is an image of a setup screen (email setup screen) to register an e-mail address on an e-mail address book in an email system. The email system may be an image forming apparatus, a computer system, etc., which has an email setup process and communicate with one or more external receivers (receiving image forming apparatuses, computer systems, etc.) through a wired or wireless communication line or network.

Referring to FIG. 1, a user may input a number in an index box to correspond to a user name and an email address to be filled in a user name section (box) and an email address section (box). However, it is possible that the number of the index box can be automatically set according to the number of previous user names or the email addresses. And, a name of a user is input on a user name box and an e-mail address of the user is input on an e-mail address box, thereby registering the name and the e-mail address of the user.

FIG. 2 is an image of a setup screen illustrating an e-mail address book in an email system.

Referring to FIG. 2, the e-mail address book includes all names (user names) and e-mail addresses of users, which are registered as described above with reference to FIG. 1.

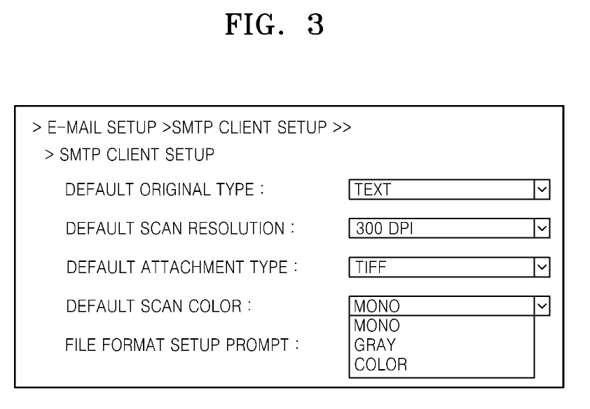

FIG. 3 is an image of a setup screen to describe a method of setting a scan option of an image file to be sent through an e-mail.

Referring to FIG. 3, when a user selects a scan option of an e-mail to be sent, a menu to select e-mail setup information is displayed. As illustrated in FIG. 3, the e-mail setup information includes, for example, an original type, a scan resolution, an attachment type, a scan color, and a file format setup prompt.

As described above with reference to FIGS. 1 through 3, when an e-mail is sent in a multifunctional printer having a scanner function, a sender selects a format of an image file to be attached to the e-mail.

In this case, if a plurality of receivers exist, the sender sends the image file having the same scan option to all of the receivers, the receiver receives the image file of which the scan option is set by the sender, and the image file does not correspond to an image format desired by the receiver. In more detail, when only one type of the scan option is provided in one time, the sender sends the same image file to all the receivers regardless of desired image formats of the respective receivers. When a receiver receives from a sender the sent email with attachment of the same format, and needs to request the sender another format different from the same format, the sender needs to resend an email with the image file with requested another format to the receiver upon the receiver's request as a new image file.

Thus, if different types of image files require to be sent to the corresponding receivers, the sender should perform a separate job to set a scanning option for each of the receivers. That is, since the scanning option on the image file format is applied to all image files scanned and then attached to the respective emails, the sender needs to change the scanning option with the another format to correspond to the receiver. In this case, the changed another format can be applied to all the image files created from a scanned document and then attached to the emails.

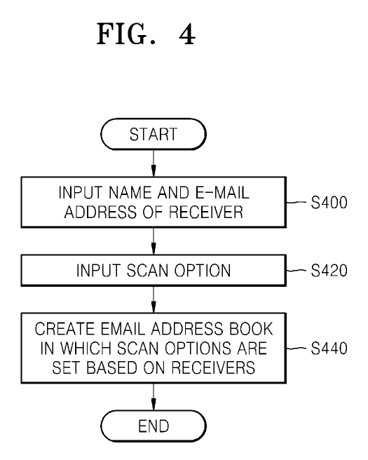

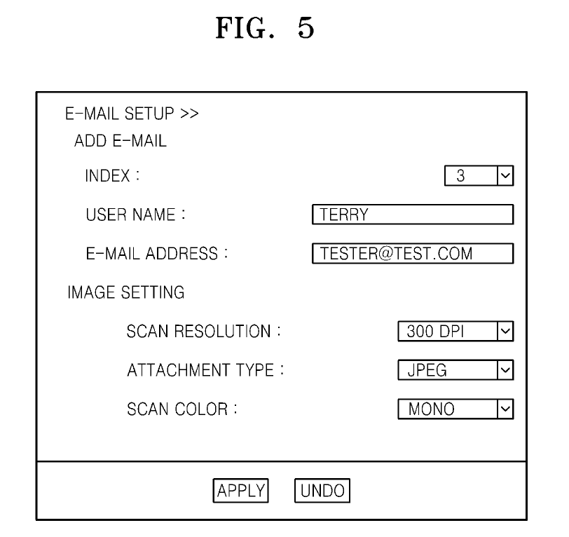

FIG. 4 is a flowchart illustrating a method of creating an e-mail address book in an image forming apparatus, according to an embodiment of the present general inventive concept. FIG. 5 is an image of a setup screen to register an e-mail address and a scan option on an e-mail address book, according to an embodiment of the present general inventive concept. By using the setup screen illustrated in FIG. 5, the e-mail address book may be created and scan options may be set based on receivers in the image forming apparatus.

The e-mail address book is created as described below. Initially, a name and an e-mail address of at least one receiver are received and stored in operation S400. As illustrated in FIG. 5, an index, a user name, and an e-mail address are input.

Then, a scan option desired by the receiver is received and stored in operation S420. The scan option may include an image file format that represents a format of an image file to be attached to an e-mail, a scan resolution that represents a scan resolution of the image file, and a scan color mode that represents whether the image file is in a color mode or a gray mode. In FIG. 5, a scan resolution box to set a resolution of a scanned image is initially selected as a scan option. Then, an attachment type box to set a format of an image file to be attached to an e-mail is selected and the format of the image file may include, for example, pdf, tiff, or jpeg. Lastly, a scan color box to set a scan color mode of the scanned image is selected and the scan color mode may include, for example, a mono mode, a gray mode, or a color mode.

After that, the e-mail address book is created by linking the name, the e-mail address, and the scanning option to the receiver, in operation S440. Therefore, a scanning option set in the email address book is not applied to all image files scanned and then attached to respective emails, but is applied to image files created from a scanned document and then attached to designated emails.

A method of sending an e-mail by using an e-mail address book in an image forming apparatus capable of scanning a document, according to an embodiment of the present general inventive concept, includes receiving basic information of at least one receiver and a scan option corresponding to the receiver; storing the basic information and the scan option in the e-mail address book, selecting a receiver from the e-mail address book, scanning the document in accordance with a scanning option corresponding to the selected receiver, and attaching the scanned document to the e-mail and sending the e-mail to the selected receiver.

The basic information includes at least one of a name, an e-mail address, and a telephone number of the receiver. The e-mail address sets and stores at least one scan option corresponding to the receiver.

Meanwhile, when the receiver is selected, if a plurality of scan options corresponding to the receiver exist in the e-mail address book, a user may select at least one of the scan options. Also, when the receiver is selected, a plurality of receivers may be selected with respect to the document and one scan option may be set for the receivers. Furthermore, when the receiver is selected, the basic information and the scan option are displayed in detail.

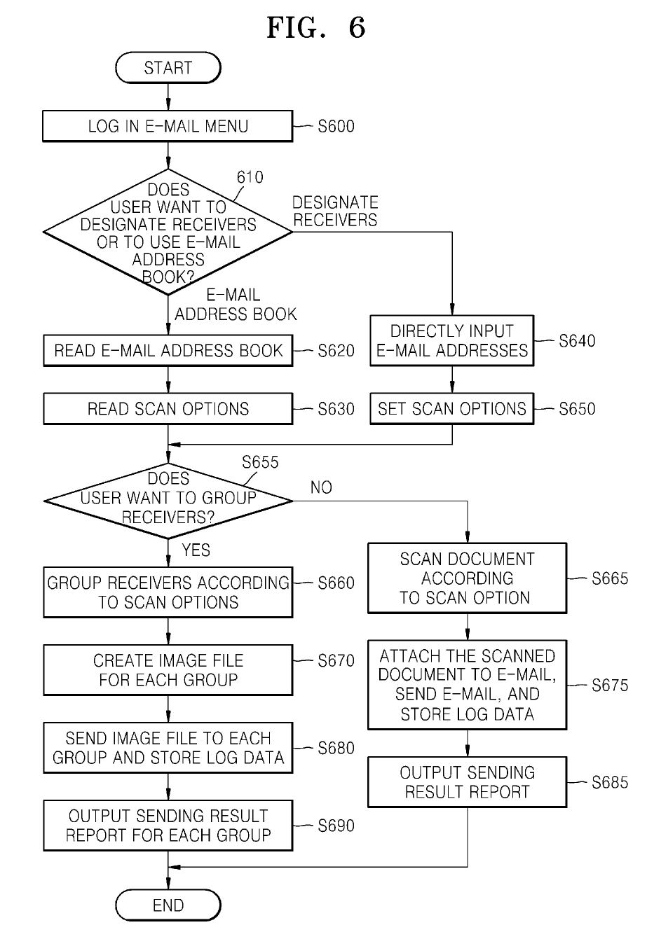

FIG. 6 is a flowchart illustrating a method of sending an e-mail in an image forming apparatus by using an e-mail address book, according to an embodiment of the present general inventive concept.

Referring to FIG. 6, a user logs in an e-mail menu in operation S600. The user determines whether to send e-mails by directly designating receivers or by using the e-mail address book, in operation S610. If the user determines to send the e-mails by using the e-mail address book, e-mail addresses of the receiver may be read from the e-mail address book in operation S620 and scan options that are set to correspond to the receivers may be read from the e-mail address book in operation S630. If the user determines to send the e-mails by directly designating the receivers, the user directly input e-mail addresses of the receivers in operation S640 and sets scan options corresponding to the receivers in operation S650.

After the scan options are determined as described above, the user determines whether to group the receivers in accordance with the scan options, in operation S655. If the user determines to group the receivers, the receivers are grouped in accordance with the scan options in operation S660. For example, if the number of scan option groups is three, the receivers may be grouped into three groups.

For example, the e-mail addresses read from the e-mail address book are as described below.

Addr 1: tester1@tester.com(Mono, PDF, 300 dpi)

Addr 2: tester2@tester.com(Mono, PDF, Don't Care)

Addr 3: tester3@tester.com(Mono, Don't Care, 300 dpi)

Addr 4: tester4@tester.com(Don't Care, TIF, 300 dpi)

Addr 5: tester5@tester.com(Color, TIF, Don't Care)

Addr 6: tester6@tester.com(Color, JPG, 300 dpi)

Addr 7: tester7@tester.com(Color, JPG, Don't Care)

In this case, the receivers may be grouped into a minimum number of groups in accordance with the scan options, as described below.

[Group 1] Scan Option (Mono, PDF, 300 dpi)

Addr 1: tester1@tester.com(Mono, PDF, 300 dpi)

Addr 2: tester2@tester.com(Mono, PDF, Don't Care)

Addr 3: tester3@tester.com(Mono, Don't Care, 300 dpi)

[Group 2] Scan Option (Color, TIF, 100 dpi)

Addr 4: tester4@tester.com(Don't Care, TIF, 300 dpi)

Addr 5: tester5@tester.com(Color, TIF, Don't Care)

[Group 3] Scan Option (Color, JPG, 200 dpi)

Addr 6: tester6@tester.com(Color, JPG, 300 dpi)

Addr 7: tester7@tester.com(Color, JPG, Don't Care)

Then, a scanned image file is created for each group in operation S670. An image file corresponding to Group 1 is sent to Group 1 and log data is stored, in operation S680. Likewise, an image file corresponding to Group 2 is sent to Group 2 and log data is stored. An image file corresponding to Group 3 is sent to Group 3 and log data is stored. After the image files are sent to the groups, the log data is processed and a sending result report is output, in operation S690.

Meanwhile, if the user determines not to group the receivers in operation S655, a document is scanned in accordance with the scan option in operation S665, and the scanned document is sent to the receivers through e-mails and log data is stored, in operation S675. After the scanned document is sent to the receivers, the log data is processed and a sending result report is output, in operation S685.

Here, the number of image conversions to be performed and the number of e-mails to be sent correspond to the number of groups having scan options different from each other.

According to the current embodiment of the present general inventive concept, scan options may be variously set when a user want to send e-mails. The scan options may be equally set or be differently set in accordance with scan options desired by receivers.

If the scan options desired by the receivers are used, each of the receivers may use a received image file without performing image conversion. As such, satisfaction of the receivers may be increased, each receiver may receive image files in the same format all the time, and a sender may more simply send the image files through e-mails.

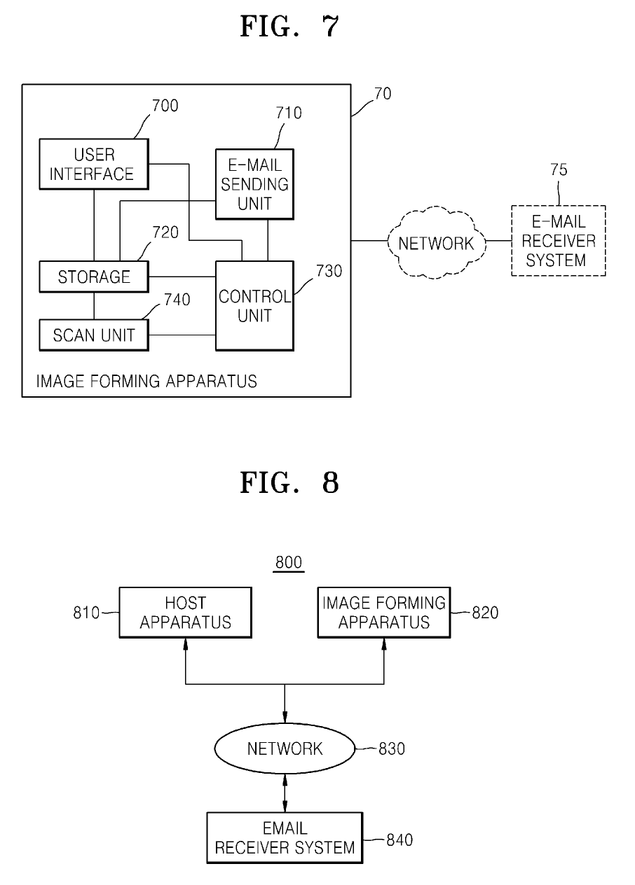

FIG. 7 is a block diagram illustrating an email system, for example, an image forming apparatus 70, to send an e-mail in accordance with scan options set based on receivers, according to an embodiment of the present general inventive concept.

Referring to FIG. 7, the image forming apparatus 70 may include a control unit 730, a scan unit 740, and an e-mail sending unit 710, and may further include a user interface 700 and a storage unit 720.

The scan unit 740 scans a document in accordance with a scan option corresponding to at least one receiver and creates an image file from the scanned document, by the control of the control unit 730. The scan option may include at least one of an image file format that represents a format of an image file to be attached to an e-mail, a scan resolution that represents a scan resolution of the image file, and a scan color mode that represents whether the image file is in a color mode or a gray mode.

The e-mail sending unit 710 attaches the scanned document to an e-mail and sends the e-mail with the attachment of the scanned document to at least one e-mail receiver system 75 corresponding to the receiver.

The user interface 700 receives basic information of the receiver and a scan option corresponding to the receiver. The basic information may include at least one of a name, an e-mail address, and a telephone number of the receiver. If a plurality of scan options corresponding to the receivers exist in an e-mail address book, the user interface 700 may select one of the scan options. Also, the user interface 700 may select a plurality of receivers with respect to the document and may set one scan option for the receivers. The user interface 700 provides the setup screen illustrated in FIG. 5 in order to receive at least the name and the e-mail address of the receiver, and the scan option desired by the receiver.

The storage unit 720 stores the e-mail address book including the basic information of the receiver and the scan option corresponding to the receiver, which are received through the user interface 700. The e-mail address book stored in the storage 720 sets at least one scan options corresponding to the receiver.

In this case, the control unit 730 creates the e-mail address book by linking the name, the e-mail address, and the scanning option, which are received through the setup screen of the user interface 700, to the receiver.

Also, the control unit 730 controls the scan unit 740 to scan the document in accordance with the basic information of the receiver and the scanning option corresponding to the receiver, and controls the e-mail sending unit 710 to attach the scanned document to the e-mail and to send the e-mail to the receiver.

Meanwhile, when the document is sent to a plurality of receivers, the control unit 730 obtains scan options of the receivers and groups the receivers in accordance with shared scan options. The grouping of the receivers is described above with reference to FIG. 6, and thus detailed descriptions thereof will be omitted here. After the control unit 730 groups the receivers, the scan unit 740 scans the document in accordance with a scan option set for each group and creates an image file, and the e-mail sending unit 710 attaches the image file to an e-mail and sends the e-mail to a corresponding group. Then, a sending result for each group may be stored in the storage 720 as log data and may be output as a sending result report.

FIG. 8 illustrates an email system having a host apparatus 810, an image forming apparatus 820, and an email receiving system 840 to receive an image from at least one of the host apparatus 810 and the image forming apparatus 820 through a network 830. The above described methods may be performed in either the host apparatus 810 or the image forming apparatus. However, the image forming apparatus 820 may include a scanning unit to perform a scanning operation to scan a document such that an image file can be created from the scanned document. The operation of setting options of emails can be performed in the host apparatus, and the host apparatus 810 can control the image forming apparatus 820 to scan a document, and then the host apparatus 810 may receive the scanned document to create an image file with a desired format. The host apparatus 810 can send the email with the image file of the desired format.

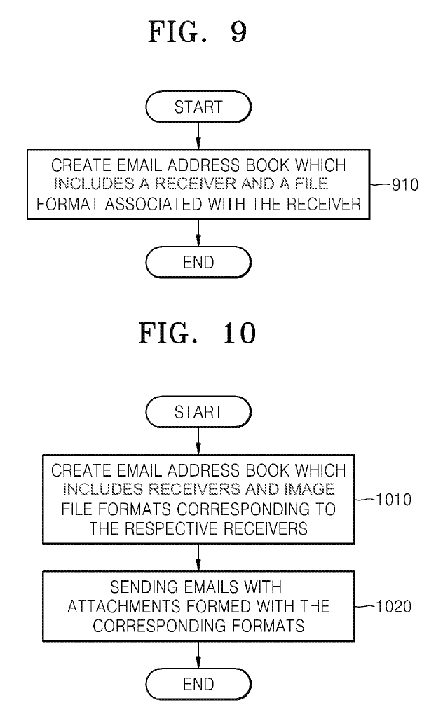

FIG. 9 illustrates a method of creating an email address book to include a receiver and a file format associated with the receiver in operation 910. When another receiver is set, the file format associated with the receiver is not applied to an email to be sent to the another receiver.

FIG. 10 illustrate a method of creating an email address book to include a pluratlity of receivers and file formats associated with the corresponding receivers in an operation 1010 and sending emails with attachments formed with the corresponding formats in operation 1020. Therefore, a first image file with a first format can be prepared and sent to a first group of receivers having the same first format option, and a second image file with a second format can be prepared and sent to a second group of receivers having the same second format option.

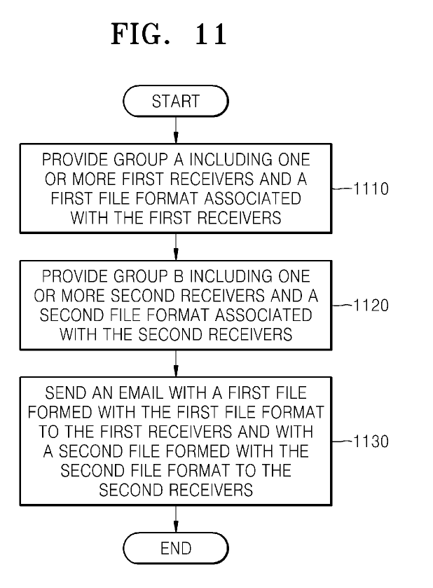

FIG. 11 illustrates a method of providing a group A including one or more first receivers and a first file format associated with the first receivers in operation 1110, providing a group B including one or more second receivers and a second file format associated with the second receivers in operation 1120, and sending an email with a first file formed with the first file format to the first receivers and with a second file formed with the second file format to the second receivers.

The present general inventive concept can also be embodied as computer-readable codes on a computer-readable medium. The computer-readable medium can include a computer-readable recording medium and a computer-readable transmission medium. The computer-readable recording medium is any data storage device that can store data as a program which can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network coupled computer systems so that the computer-readable code is stored and executed in a distributed fashion. The computer-readable transmission medium can transmit carrier waves or signals (e.g., wired or wireless data transmission through the Internet). Also, functional programs, codes, and code segments to accomplish the present general inventive concept can be easily construed by programmers skilled in the art to which the present general inventive concept pertains.

According to the present general inventive concept, a receiver may receive image files in the same format and may conveniently use the image files without performing image conversion. A sender may more simply send the image files through e-mails.

While the present general inventive concept has been particularly shown and described with reference to exemplary embodiments thereof, it will be understood by those of ordinary skill in the art that various changes in form and details may be made therein without departing from the spirit and scope of the present general inventive concept as defined by the following claims.

What is claimed is:

1. A method of sending an e-mail by using an e-mail address book in an image forming apparatus capable of scanning a document, the method comprising:
receiving basic information of at least one receiver and a scan option corresponding to the at least one receiver;
storing the basic information and the scan option in the e-mail address book;
selecting a receiver from the e-mail address book;
scanning the document in accordance with a scanning option corresponding to the selected receiver; and
attaching the scanned document to the e-mail and sending the e-mail to the selected receiver.

2. The method of claim 1, wherein the basic information comprises at least one of a name, an e-mail address, and a telephone number of the at least one receiver.

3. The method of claim 1, wherein the storing of the basic information and the scan option comprises setting at least one scan option corresponding to the at least one receiver.

4. The method of claim 1, wherein the selecting of the receiver comprises, if a plurality of scan options corresponding to the receiver exist in the e-mail address book, selecting at least one of the plurality of scan options by a user.

5. The method of claim 1, wherein the selecting of the receiver comprises selecting a plurality of receivers with respect to the document.

6. The method of claim 5, wherein one scan option is set for the plurality of receivers.

7. The method of claim 1, wherein the selecting of the receiver comprises displaying the basic information and the scan option in detail.

8. An image forming apparatus comprising:
a scan unit to scan a document in accordance with a scan option corresponding to at least one receiver;
an e-mail sending unit to attach the image file to an e-mail and sending the e-mail to the at least one receiver;
a user interface to receive basic information of the at least one receiver and a scan option corresponding to the at least one receiver;
a storage to store an e-mail address book having the basic information and the scan option; and
a control unit to control the scan unit to scan the document in accordance with the basic information and the scan option, and to control the e-mail sending unit to attach the scanned document to the e-mail and to send the e-mail to the at least one receiver.

9. The apparatus of claim 8, wherein the basic information comprises at least one of a name, an e-mail address, and a telephone number of the at least one receiver.

10. The apparatus of claim 8, wherein the e-mail address book stored in the storage sets at least one scan option corresponding to the at least one receiver.

11. The apparatus of claim 8, wherein, if a plurality of scan options corresponding to the at least one receiver exist in the e-mail address book, the user interface selects at least one of the plurality of scan options.

12. The apparatus of claim 8, wherein the user interface selects a plurality of receivers with respect to the document.

13. The apparatus of claim 12, wherein the user interface sets one scan option for the plurality of receivers.

14. The apparatus of claim 8, wherein the user interface displays the basic information and the scan option in detail.

15. An apparatus to send an email according to an email option of a document scanned in an image forming apparatus, comprising:
a user interface to set the email option applied to a designated receiver; and
a controller to send the email with an attachment formed according to the set email option to the designated receiver.

16. The apparatus of claim 15, wherein the user interface sets another email option applied to another designated email, and the controller sends anther email with another attachment according to the set another email option of the another designated receiver.

17. The apparatus of claim 16, wherein the first email option is not applied to the second email and the second email option is not applied to the first email.

18. The apparatus of claim 16, wherein the first email option is a first format of the attachment, and the second email option is a second format of the another attachment.

19. The apparatus of claim 16, further comprising:
a scanning unit to scan a document,
wherein the controller creates the attachment from the scanned document according to the email option and creates the another attachment from the scanned document according to the another email option.

20. The apparatus of claim 15, wherein:
the email option comprises a plurality of email options;
the receiver comprises a plurality of receivers;
the user interface creates an email address book having a first group of receivers having the same one of the email options and a second group of receivers having the same another one of the email options.
